(19) United States
(12) Patent Application Publication
(10) Pub. No.: US 2026/0154806 A1
(43) Pub. Date: Jun. 4, 2026

(54) SYSTEM FOR IR DROP PREDICTION OF A PACKAGE DESIGN AND A CHIP PRODUCT PACKAGED IN THE PACKAGE DESIGN

(71) Applicant: MEDIATEK INC., Hsinchu City (TW)

(72) Inventor: Hao-Wei CHAN, Hsinchu City (TW)

(21) Appl. No.: 19/328,513

(22) Filed: Sep. 15, 2025

Related U.S. Application Data
(60) Provisional application No. 63/726,682, filed on Dec. 2, 2024.

(51) Int. Cl. G06T 7/00; G06T 7/50

(52) U.S. Cl. CPC G06T 7/001; G06T 7/50; G06T 2207/10016; G06T 2207/20016; G06T 2207/20084; G06T 2207/20216; G06T 2207/30148

(57) ABSTRACT

IR drop prediction of a package design is shown. An encoder implemented by a hierarchical vision transformer, and a decoder with package inductance decoding are required. The encoder regards a plurality of layers of a package layout as a plurality of frames of a video, to process the layers of the package layout based on query bump maps. The decoder integrates different scales of output from the encoder. Based on the height information of each layer of the package layout, inductance maps corresponding to the different query bump maps are generated from decoded output of the decoder, and a bump-to-bump inductance matrix including self-inductance and mutual inductance of queried bumps is obtained from the inductance maps for the IR drop prediction.

### CROSS REFERENCE TO RELATED APPLICATIONS

This application claims the benefit of U.S. provisional application No. 63/726,682, filed Dec. 2, 2024, the entirety of which is incorporated by reference herein.

### TECHNICAL FIELD

The present disclosure relates to chip packaging.

### BACKGROUND

In semiconductor packaging, the power distribution network (PDN) is crucial to provide stable power to various components. An IR drop is a voltage drop caused by resistance and inductance in the power delivery path. Ensuring minimal IR drop (and hence minimal voltage fluctuation) is essential for the reliable operation of high-performance semiconductor devices. An IR drop that is too large may lead to poor semiconductor device performance, timing problems, and even functional failure. Managing the IR drop is critical to maintaining the integrity and performance of PDN.

Flip-chip chip-scale packages (FCCSPs) are widely used in high-performance applications due to their superior electrical and thermal performance. FIG. 1 illustrates an FCCSP structure 100, which connects to a printed circuit board (PCB) (not shown) through solder balls 102. Between the substrate 104 and the mold 106, the area 108 is underfill. The die 110 of a chip is flipped, and connected to the substrate 104 of the package through (die) bumps 112. In such an FCCSP structure 100, a voltage drop accumulates along the current path from the solder ball layer (102) to the metal layer and then to the bump layer (104). Accurately predicting and managing the voltage drop in the FCCSP structure 100 is important to ensure optimal performance and reliability.

Engineers typically rely on Electronic Design Automation (EDA) tools to evaluate and optimize the power distribution network (PDN) in a semiconductor package. These tools perform sophisticated circuit simulations to predict IR drop due to the package layout. The simulation process involves layout design, simulation setup, circuit simulation, and iterative optimization. With EDA tools, the electrical behavior of PDN can be simulated based on the effects of resistance (R), inductance (L), and capacitance (C). These simulations provide insight into voltage fluctuations and help identify critical IR drop issues. Based on the simulation results, engineers iteratively modify the layout to improve the PDN design.

However, although the EDA tool simulations are sophisticated and accurate, significant computational resources are required. The simulation of a complex package design may take hours, resulting in long design cycles. The iterative nature of EDA tool simulations and the more and more complex semiconductor packaging increase the time required to design an optimal PDN. The evaluation and optimization of PDN may be considerably delayed. The increased simulation time becomes a bottleneck in the chip design process.

In the competitive semiconductor industry, reducing time to market is critical to maintaining a competitive advantage. Lengthy simulation and design iteration processes hinder the rapid launch of new products. We need faster and more efficient technology to predict and manage voltage drop in PDNs.

### BRIEF SUMMARY

A system based on an artificial intelligence architecture for IR drop prediction of a package design is shown. The system includes an encoder implemented by a hierarchical vision transformer, and a decoder with package inductance decoding. The encoder regards a plurality of layers of a package layout as a plurality of frames of a video, to process the layers of the package layout based on query bump maps. The decoder integrates different scales of output from the encoder. Based on the height information of each layer of the package layout, inductance maps corresponding to the different query bump maps are generated from decoded output of the decoder, and a bump-to-bump inductance matrix including self-inductance and mutual inductance of queried bumps is obtained from the inductance maps for the IR drop prediction.

In an exemplary embodiment, the decoder includes hierarchical stages corresponding to the different scales of output from the encoder. Each hierarchical stage of the decoder includes a package inductance decoder that performs a channel mean calculation for each hierarchical stage.

In an exemplary embodiment, for the generation of the inductance maps, decoded outputs obtained from the package inductance decoders of the different hierarchical stages are element-wise multiplied by a stack-up scaler that is obtained from the height information of the different layers of the package layout.

In an exemplary embodiment, a chip product packaged in a package design configured using the system is shown.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 illustrates an FCCSP structure 100;

FIG. 2 illustrates a system AI_sys for IR drop prediction of a package design in accordance with an exemplary embodiment;

FIG. 3 illustrates the details of the 3D VSwin transformer 302 in accordance with an exemplary embodiment of the disclosure;

FIG. 4 illustrates a 2D DCMNet 402 implementing the decoder 204, and further shows the details of the stack-up embedder 206; and

FIG. 5 illustrates the details of a PID 404, which introduces a 3×3 CBR process 502, and then a 1×1 convolution process 504, and then a channel mane process 506.

### DETAILED DESCRIPTION

The following description enumerates various embodiments of the disclosure, but is not intended to be limited thereto. The actual scope of the disclosure should be defined according to the claims. The various functional blocks/modules mentioned below may be implemented by a combination of hardware, software, and firmware, and may also involve circuit implementation. The various functional blocks/modules are not limited to being implemented separately, but can also be combined together to share certain functions.

As process shrinks, IR drop becomes critical during sign-off due to increased power density and reduced noise margin, extending to on-chip and package design. In the disclosure, the package layout is represented as images, and a novel framework for predicting IR drop on the Power Delivery Network (PDN) of a package is proposed, which is a transformer-based computer vision model.

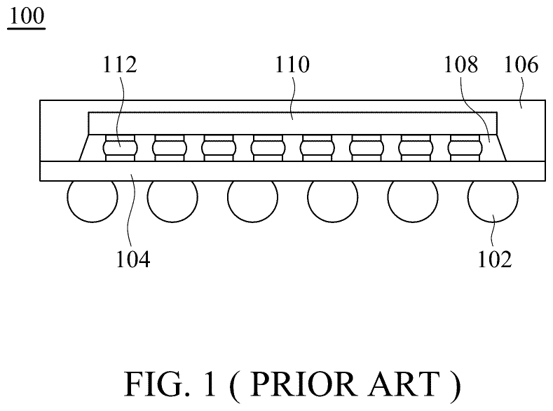

In an exemplary embodiment, the transformer-based computer vision model is for flip-chip chip-scale packages (FCCSPs, referring to FIG. 1). The FCCSP structure 100 has metal layers between the bump layer (112) and the solder ball layer (102). The number of metal layers and layout style can vary between low-end and high-end products due to cost and performance considerations. The quality of the package PDN is usually assessed by measuring the self-inductance of each bump 112. However, as the currents flow from the solder balls 102 to the bumps 112, the mutual inductance between bumps becomes the dominant contributor to the dynamic IR drop analysis. Therefore, modeling each bump 112 by its associated self-inductance is not sufficient to quantitatively estimate the package dynamic IR drop. Both the self-inductance of each bump 112 and mutual inductance between every pair of bumps in the package layout—which will later be multiplied by the time differential of the load current to calculate the dynamic IR drop of the bumps—are of significant importance to package layout design.

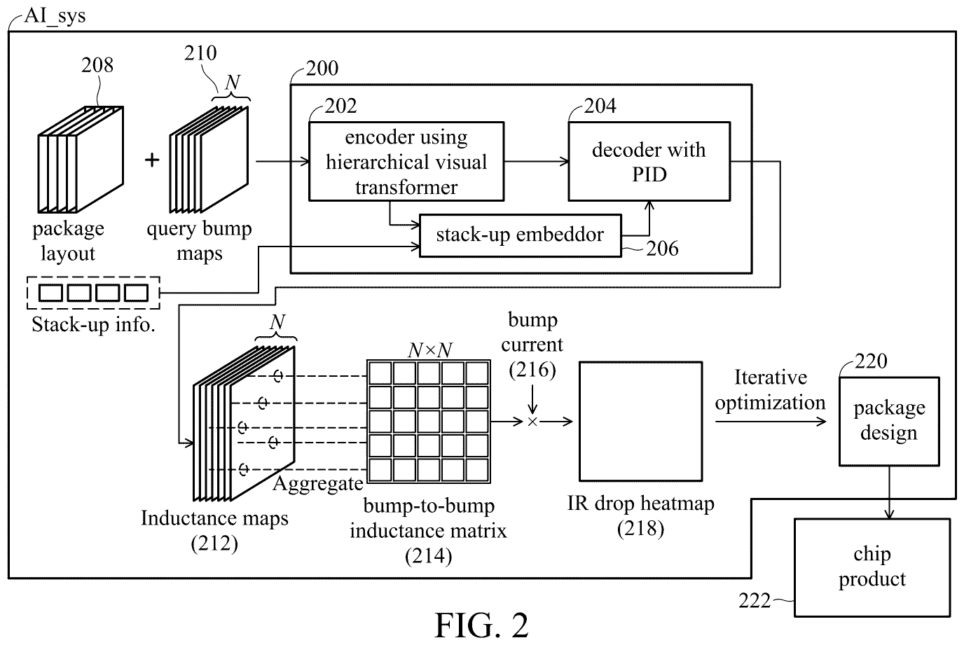

FIG. 2 illustrates a system AI_sys for IR drop prediction of a package design in accordance with an exemplary embodiment. The system AI_sys is based on an artificial intelligence (AI) architecture, including a transformer-based computer vision model 200. The system AI_sys may be any computing system. The model 200 includes an encoder 202 using a hierarchical vision transformer, a decoder 204 with package inductance decoding (PID), and a stack-up embedder 206. The system AI_sys achieves IR drop prediction by inductance prediction. Inductance prediction involves inputting a package layout 208 (including multiple layers) and query bump maps 210 into the model 200. The transformer-based computer vision model 200 considers each package layer as a discrete frame, akin to a video sequence. This analogy enables the model 200 to be universally applicable, irrespective of the number of package layers. To apply an image-to-image approach to predict the bump inductance in relation to a specific bump, referred to as the “queried bump”, in the package layout 208, the query bump maps 210 are required. Given that each bump interacts with every other bump in the package layout 208, it is crucial to specify to the model 200 which bump is the queried bump, and how other bumps will interact with it.

The encoder 202, implemented by a hierarchical vision transformer, regards a plurality of layers of a package layout 208 as a plurality of frames of a video to process the layers of the package layout 208 based on the query bump maps 210. The number of the query bump maps 210 is N, which is a variable number, depending on the number (N) of query bumps. Each query bump corresponds to one query bump map. The decoder 204 with PID is coupled to the encoder 202 to integrate different scales of output from the encoder 202. Based on the height information of each layer of the package layout 208 (provide by the stack-up embedder 206), inductance maps 212 corresponding to the different query bump maps 210 are generated from decoded output of the decoder 204, and a bump-to-bump inductance matrix 214 including self-inductance and mutual inductance of all query bumps is obtained from the inductance maps 212 for the IR drop prediction. By multiplying the bump-to-bump inductance matrix 214 by bump current profiles (referring to the bump current 216), the IR drop of the package design is predicted. The hotspots of the predicted IR drop are presented in an IR drop heatmap 218. Through iterative optimization, an ideal package design 220 is configured by the system AI_sys. A chip product 222 packaged in the package design 220 is manufactured.

The bump-to-bump inductance matrix 214 may be denoted as L∈ [symbol] ^{N×N}. Each element, L_{i,j} in L, represents the voltage induced in the i-th bump due to the rate of change of current in the j-th bump. The IR drop of the bumps on the FCCSP can be expressed as IR(t)=L·(dI(t)/dt), where IR(t)∈ [symbol] ^{N} and I(t)∈ [symbol] ^{N} denote the IR drop and bump currents at time t, respectively. The i-th row in the bump-to-bump inductance matrix 214 corresponding to the i-th bump. The predicted bump-to-bump inductance matrix L (214) is multiplied by the time differential of the bump currents (e.g., the bump current profiles), and thereby the dynamic IR drop on the PDN is predicted.

Among the various hierarchical vision transformers, the video Swin transformer (which we refer to as a 3D VSwin transformer) is distinguished by its superior performance, efficient memory utilization, and its capability to encapsulate global information within image data. In an exemplary embodiment, the model 200 uses a 3D VSwin transformer as the encoder 202. Such an encoder 202 facilitates the rapid prediction of inductance within FCCSP designs.

The 3D VSwin transformer implementing the encoder 202 is the core building block of the model 200. Given that the package layout 208 can vary in the number of layers, we opt for the 3D VSwin transformer, treating layers as temporal frames. This approach allows us to use a single model 200 to manage data with varying numbers of layers.

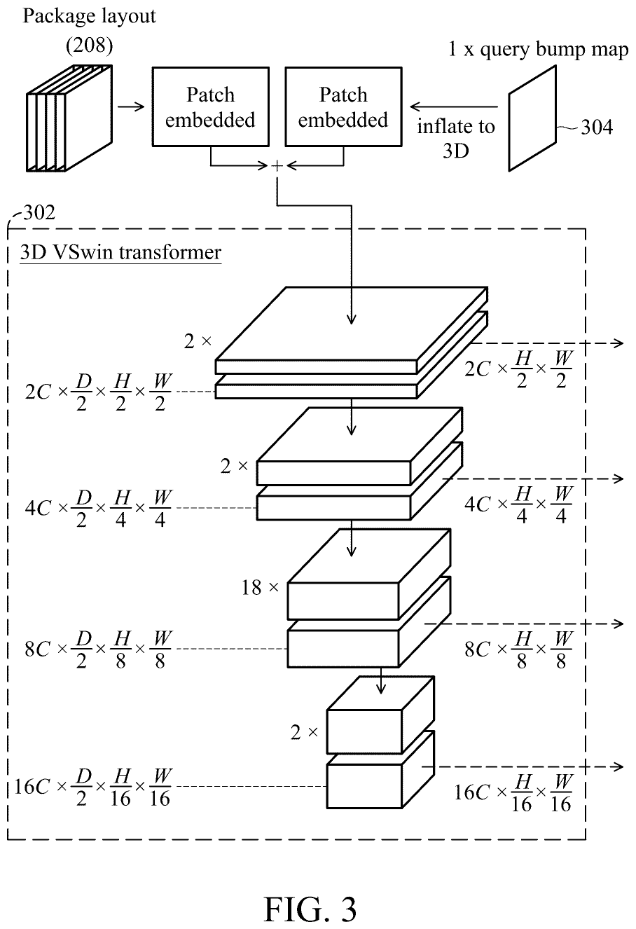

FIG. 3 illustrates the details of the 3D VSwin transformer 302 in accordance with an exemplary embodiment of the disclosure. In the figures, ‘x’ means tensor product, ‘+’ means tensor addition, and ‘-->’ shows a mean in depth dimension. ‘D’, ‘H’, and ‘W’ are resolution coefficients. ‘C’ is coefficient of the 3D VSwin transformer 302.

Before input to the 3D VSwin transformer 302, the package layout 208 and the i-th query bump map 304 are passed through their respective patch embeddings. Since the package layout 208 has multiple layers in the depth dimension and the i-th query bump map 304 has only 1, the i-th query bump map 304 is inflated to the same number of layers as the package layout 208 before the patch embedding. The patches of package layout 208 and patches of inflated query bump map are added together to form frames of a video. The 3D VSwin transformer 302 treats the stack of the input data as a video (or 3D images) and extracts the 3D feature maps with different resolutions and receptive fields. Different scales of output are generated. In the exemplary embodiment, the depth dimension (D) is not further down-scaled post the patch embedding layers since the depth (D) is considerably less than its height (H) and width (W).

As for the decoder 204 and the stack-up embedder 206 of FIG. 2, the decoder 204 may be a Densely Cascaded Multi-scale Network (DCMNet), which performs 2D operations and fuses the 2D feature maps via top-down cascade pathways. The stack-up embedder 206 incorporates stack-up information (height information of each metal and dielectric layer) into the model 200.

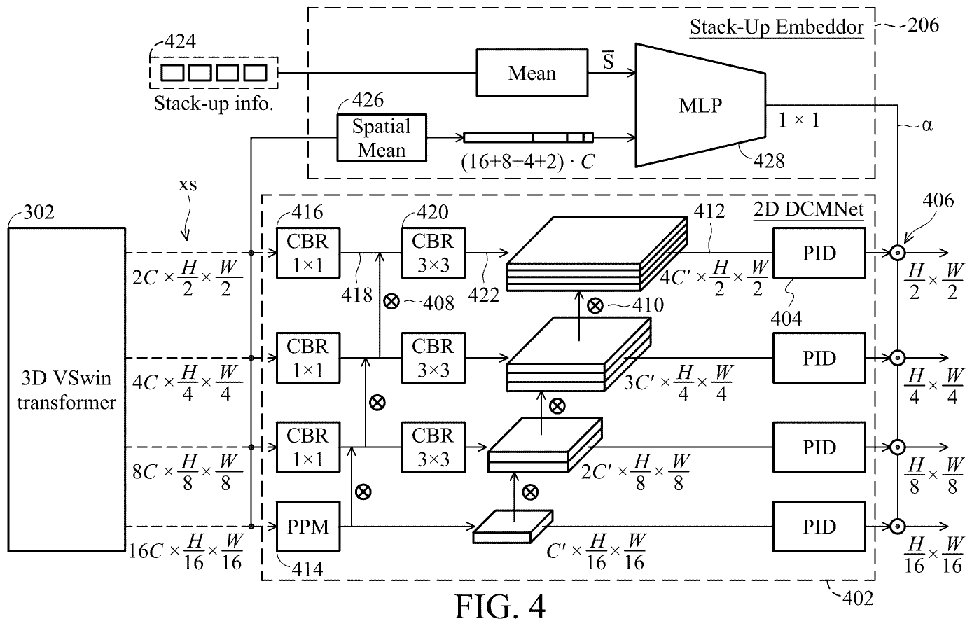

FIG. 4 illustrates a 2D DCMNet 402 implementing the decoder 204, and further shows the details of the stack-up embedder 206.

Outputs, corresponding to the different scales, from the 3D VSwin transformer 302 are separately averaged in depth (e.g., through average pooling represented by ‘-->’) to be converted from 3D to 2D before decoding. Corresponding to the different scales of output from the 3D VSwin transformer 302, the 2D DCMNet 402 includes hierarchical stages. Each hierarchical stage of the 2D DCMNet 402 includes a package inductance decoder (PID) 404, that performs at least a channel mean calculation or is implemented by a convolutional neural network (CNN). To generate the inductance maps 212 (referring to FIG. 2), decoded outputs obtained from the package inductance decoders (PID) 404 of the different hierarchical stages are element-wise multiplied (through 406) by a stack-up scaler α from the stack-up embedder 206, wherein the tack-up scaler α is obtained from the height information of the different layers of the package layout 208.

As shown, the 2D DCMNet 402 integrates the different scales of output from the 3D VSwin transformer 302 using a first bilinear interpolation process 408 with element-wise addition and a second bilinear interpolation process 410 with channel-wise concatenation. After the first bilinear interpolation process 408 and the second bilinear interpolation process 410, signals (referring to 412) in the different hierarchical stages are separately transferred to the corresponding package inductance decoders (PID) 404.

The 2D DCMNet 402 has a pyramid pooling module (PPM) 414 in the lowest hierarchical stage corresponding to the lowest resolution ( 1/16). From the second-lowest hierarchical stage to the highest hierarchical stage corresponding to the second-lowest resolution (⅛) to the highest resolution (½), each stage performs a first process of 1×1 Convolution-BatchNorm-ReLU (CBR 1×1) 416. The output of the PPM 414 is integrated into the output 418 of the first process (CBR 1×1) of the highest hierarchical stage using a first bilinear interpolation process 408 (with element-wise addition), wherein the first bilinear interpolation process 408 is performed from the lower hierarchical stage to the higher hierarchical stage.

Each stage, from the second-lowest hierarchical stage to the highest hierarchical stage, performs a second process of 3×3 Convolution-BatchNorm-ReLU (CBR 3×3) 420 after the first bilinear interpolation process 408. The output of the PPM 414 is also integrated into an output 422 of the second process 420 of the highest hierarchical stage using a second bilinear interpolation process 410 (with channel-wise concatenation), wherein the second bilinear interpolation process 310 is performed from the lower hierarchical stage to the higher hierarchical stage.

The stack-up embedder 206 generates the stack-up scaler α based on the mean value s of the stack-up information 424 (height information of each metal and dielectric layer of the package layout 208). In the generation of the stack-up scaler α, the stack-up embedder further considers spatial mean values obtained from the 3D VSwin encoder 302 through the special mean block 426. Each spatial mean value corresponds to one scale of output of the 3D VSwin encoder 302.

As shown, the stack-up embedder 206 includes a multilayer perceptron (MLP, e.g., including two layers) 428, receiving the mean value s̅ of the height information of the different layers of the package layout 208 and the spatial mean values obtained from the 3D VSwin encoder 302 to generate the stack-up scaler α. The stack-up scaler α is applied to the tensor output of each hierarchical stage of the 2D DCMNet 402.

The height information of each metal and dielectric layer significantly influences the absolute value of the inductance. For accurate inductance prediction, the stack-up information 424 is integrated into the model 200. Considering the input package layout 208 may consist of various layers, the model 200 cannot allocate a fixed size for the stack-up information 424. Instead of using individual layer information, the mean value of the stack-up across all layers is used. The stack-up scaler α is determined by processing the mean height values through the MLP 428, as denoted as MLP(·). The calculation is:

$$α = MLP ( {μ}_{sp} ( x 1 ) , … , {μ}_{sp} ( x 4 ) , \overline{s} )$$

μₛₚ(·) represents the spatial mean function (426), xs is the s-th stage output of the 3D VSwin encoder 302, and s̅ stands for the mean value of the stack-up information 424. This calculated stack-up scaler, α, is subsequently applied to the tensor produced by the output of 2D DCMNet 402 through the element-wise multiplication 406.

The 2D DCMNet 402 is designed to establish direct connections between every feature map from different scales via a top-down cascade pathway, enhances the interplay among decoding layers, thereby yielding high quality multi-scale depth outputs. Compared to the standard convolution block, the 2D DCMNet 402 uses the Convolution-BatchNorm-ReLU (CBR) blocks 416 and 420, which promote faster convergence and improved regularization effects. Hierarchical features xs at four distinct resolutions (½, ¼, ⅛, 1/16) from the 3D Vswin encoder 302 are first averaged in the depth dimension, converting the 3D image to 2D, as only a single output layer is required. These features are then fed into each hierarchical stage of the 2D DCMNet 402. The feature of the lowest resolution ( 1/16) is directed to the PPM 414, which aggregates contextual information across various average pooling scales, providing global prior representations. The top-down cascade pathway then ensures the interconnection of features from different hierarchical stages through element-wise addition followed by bilinear interpolation (referring to 408, which means bilinear interpolation plus addition). Then, channel-wise concatenation of all elements following bilinear interpolation (referring to 410, which means bilinear interpolation plus concatenation). Note that each stage further introduces the package inductance decoder (PID) 404 after the bilinear interpolation plus concatenation process 410 and prior to the element-wise multiplication 406.

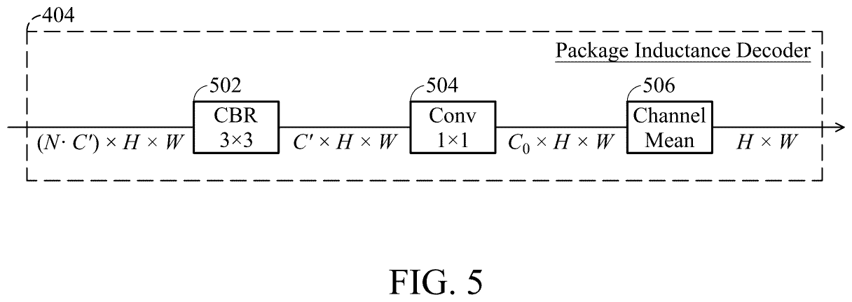

FIG. 5 illustrates the details of a PID 404, which introduces a 3×3 CBR process 502, and then a 1×1 convolution process 504, and then a channel mane process 506. After the PID 404, the element-wise multiplication 406 with the stack-up scaler α is performed. The PID 404 implemented as such a convolutional neural network (CNN) further improves the accuracy of the IR drop prediction.

In an exemplary embodiment, the package layout 208 is segmented into clips. By sliding a window, the entire package layout 208 is traversed, and inductance map clips corresponding to the layout clips are generated, and then are consolidated into a single inductance map, completing the prediction for the queried bump.

To train the transformer-based computer vision model 200, layout designs with varying numbers of metal and dielectric layers are gathered, to ensure a diverse dataset to cover different design scenarios. To further augment the dataset, the layout pictures of the training layout may be rotated (e.g., 90°, 180°, 270°, . . . ) and/or flipped and/or cropped to increase the diversity and robustness of the dataset. Augmentation helps the transformer-based computer vision model 200 generalize better to unseen data.

In the training, a reverse Huber (berHu) loss function may be adopted to address the heavy-tailed distribution of IR-drop values. To optimize the training result, a Stochastic Weight Averaging (SWA) and a cosine annealing scheduler for optimization may be employed. In this way, better generalization and convergence are achieved.

In an exemplary embodiment, traces and polygons of the training layout and the package layout to be designed are colored and weighted before export.

In conclusion, the transformer-based computer vision model 200 treats each package layer as a frame in a video. Therefore, it can handle different numbers of package layers. By conceptualizing the package layers as frames in a video, the transformer-based computer vision model 200 leverages the temporal coherence and spatial relationships, and handles various package configurations without hindrance. The prediction of inductance matrix and IR drop is accurate and efficient.

The flexibility of the transformer-based computer vision model 200 makes it applicable to design package for different numbers of metal and dielectric layers. The transformer-based computer vision model 200 simplifies the prediction process with enhanced robustness.

Compared to the traditional EDA tools, the transformer-based computer vision model 200 offers a tenfold increase in prediction speed. This significant acceleration reduces the time required for evaluating PDNs, enabling faster design iterations.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A system for IR drop prediction of a package design, comprising:
an encoder, implemented by a hierarchical vision transformer, regarding a plurality of layers of a package layout as a plurality of frames of a video to process the layers of the package layout based on query bump maps; and
a decoder with package inductance decoding, coupled to the encoder to integrate different scales of output from the encoder;
wherein:
based on height information of each layer of the package layout, inductance maps corresponding to the different query bump maps are generated from decoded output of the decoder, and a bump-to-bump inductance matrix including self-inductance and mutual inductance of query bumps is obtained from the inductance maps for the IR drop prediction.

2. The system for IR drop prediction as claimed in claim 1, wherein:
corresponding to the different scales of output from the encoder, the decoder includes hierarchical stages; and
each hierarchical stage of the decoder includes a package inductance decoder that performs a channel mean calculation for each hierarchical stage.

3. The system for IR drop prediction as claimed in claim 2, wherein:
to generate the inductance maps, decoded outputs obtained from the package inductance decoders of the different hierarchical stages are element-wise multiplied by a stack-up scaler that is obtained from the height information of the different layers of the package layout.

4. The system for IR drop prediction as claimed in claim 3, wherein:
in each hierarchical stage of the decoder, the package inductance decoder is implemented as a convolutional neural network.

5. The system for IR drop prediction as claimed in claim 4, wherein:
in each hierarchical stage of the decoder, the package inductance decoder performs a 3×3 Convolution-BatchNorm-ReLU process and then a 1×1 convolution process and then the channel mean calculation.

6. The system for IR drop prediction as claimed in claim 3, wherein:
the decoder integrates the different scales of output from the encoder using a first bilinear interpolation process with element-wise addition and a second bilinear interpolation process with channel-wise concatenation; and
after the first bilinear interpolation process and the second bilinear interpolation process, signals in the different hierarchical stages are separately transferred to the corresponding package inductance decoders.

7. The system for IR drop prediction as claimed in claim 6, wherein:
the decoder has a pyramid pooling module in the lowest hierarchical stage corresponding to the lowest resolution;
from the second-lowest hierarchical stage to the highest hierarchical stage corresponding to the second-lowest resolution to the highest resolution, each stage performs a first process of 1×1 Convolution-BatchNorm-ReLU; and
an output of the pyramid pooling module is integrated into an output of the first process of the highest hierarchical stage using the first bilinear interpolation process with element-wise addition, wherein the first bilinear interpolation process is performed from the lower hierarchical stage to the higher hierarchical stage.

8. The system for IR drop prediction as claimed in claim 7, wherein:
each stage, from the second-lowest hierarchical stage to the highest hierarchical stage, performs a second process of 3×3 Convolution-BatchNorm-ReLU after the first bilinear interpolation process; and
the output of the pyramid pooling module is also integrated into an output of the second process of the highest hierarchical stage using the second bilinear interpolation process with channel-wise concatenation, wherein the second bilinear interpolation process is performed from the lower hierarchical stage to the higher hierarchical stage.

9. The system for IR drop prediction as claimed in claim 3, further comprising:
a stack-up embedder, generating the stack-up scaler based on a mean value of the height information of the different layers of the package layout.

10. The system for IR drop prediction as claimed in claim 9, wherein:
in generating the stack-up scaler, the stack-up embedder further considers spatial mean values obtained from the encoder; and
each spatial mean value corresponds to one scale of output of the encoder.

11. The system for IR drop prediction as claimed in claim 10, wherein:
the stack-up embedder includes a multilayer perceptron, receiving the mean value of the height information of the different layers of the package layout and the spatial mean values obtained from the encoder to generate the stack-up scaler.

12. The system for IR drop prediction as claimed in claim 3, wherein:
outputs, corresponding to the different scales, from the encoder are separately averaged in depth to be converted from 3D to 2D before decoding.

13. The system for IR drop prediction as claimed in claim 12, wherein:
a queried bump map selected from the query bump maps corresponding to a queried bump is inflated to the same number of layers as the package layout and then combined into the layers of the package layout to input the encoder as frames of a video.

14. The system for IR drop prediction as claimed in claim 13, wherein:
before being combined together, the layers of the package layout are passed through patch embedding, and inflated images of the queried bump map are also passed through patch embedding.

15. The system for IR drop prediction as claimed in claim 14, wherein:
the encoder extracts 3D feature maps with different resolutions and receptive fields, to generate the different scales of output to the decoder.

16. The system for IR drop prediction as claimed in claim 15, wherein:
the encoder is a 3D Vswin transformer; and
the decoder is a 2D densely cascaded multi-scale network.

17. The system for IR drop prediction as claimed in claim 13, wherein:
with respect to the queried bump, a row of the bump-to-bump inductance matrix is obtained from the inductance maps.

18. The system for IR drop prediction as claimed in claim 17, wherein:
the IR drop of the package design is predicted by multiplying the bump-to-bump inductance matrix by bump current profiles.

19. The system for IR drop prediction as claimed in claim 3, wherein:
training data for deep-learning of the system is augmented from a training layout by image rotation, flipping, and cropping.

20. The system for IR drop prediction as claimed in claim 19, wherein:
traces and polygons of the training layout and the package layout to be designed are colored and weighted before export.

21. A chip product packaged in a package design configured using the system of claim 1.
